(19) United States
(12) Patent Application Publication
(10) Pub. No.: US 2013/0271971 A1
(43) Pub. Date: Oct. 17, 2013

(54) LIGHT-EMITTING CIRCUIT AND LUMINAIRE

(71) Applicants: Kozo Uemura, Kanagawa-ken (JP); Kiyoshi Nishimura, Kanagawa-ken (JP); Soichi Shibusawa, Kanagawa-ken (JP); Nobuhiko Betsuda, Kanagawa-ken (JP); Shuhei Matsuda, Kanagawa-ken (JP); Masatoshi Kumagai, Kanagawa-ken (JP)

(72) Inventors: Kozo Uemura, Kanagawa-ken (JP); Kiyoshi Nishimura, Kanagawa-ken (JP); Soichi Shibusawa, Kanagawa-ken (JP); Nobuhiko Betsuda, Kanagawa-ken (JP); Shuhei Matsuda, Kanagawa-ken (JP); Masatoshi Kumagai, Kanagawa-ken (JP)

(73) Assignee: TOSHIBA LIGHTING & TECHNOLOGY CORPORATION, Kanagawa (JP)

(21) Appl. No.: 13/819,296

(22) PCT Filed: Sep. 27, 2011
(86) PCT No.: PCT/JP2011/072039

§ 371 Date: Jun. 27, 2013

(30) Foreign Application Priority Data
Sep. 27, 2010 (JP) 2010-216139
Sep. 27, 2010 (JP) 2010-216229

(51) Int. Cl. F21S 2/00

(52) U.S. Cl. CPC F21S 2/00
USPC 362/223

(57) ABSTRACT

A light-emitting circuit is formed as a straight tube in a stable shape and capable of appropriately housing and holding an LED module and the like. The light-emitting circuit includes: a plurality of light-emitting elements configured to emit light; a substrate, functioning as an arrangement member, including an arrangement surface on which the plurality of light-emitting elements are arranged; and a substantially cylindrical lamp body including a translucent section at least in a part thereof, including the arrangement member disposed on the inside, and including a louver functioning as a projecting body projecting from an inner wall opposed to the arrangement surface and extending toward the arrangement surface.

### TECHNICAL FIELD

Embodiments of the present invention relate to a light-emitting circuit and a luminaire in which light-emitting elements such as LEDs are used.

### BACKGROUND ART

In a fluorescent lamp-type LED lamp, an LED module is arranged along the longitudinal direction of an elongated tube that forms a lamp body. That is, when viewed from a side portion of the tube, the LED module is arranged in a position on a plane including a line extending in the longitudinal direction through the center. Therefore, light is not irradiated in the opposite direction opposed to an irradiating direction from the LED module. There a problem in luminous intensity distribution.

It is likely that the elongated tube and the LED module bend. Therefore, there is a demand for a light-emitting circuit such as a fluorescent lamp-type LED lamp formed as a straight tube in a stable shape.

### CITATION LIST

### Patent Literature

PLT 1: JP-A-2001-351402

### SUMMARY OF INVENTION

### Technical Problem

The present invention has been devised in order to solve the problems of the related art explained above and it is an object of the present invention to provide a light-emitting circuit formed as a straight tube in a stable shape and capable of appropriately housing and holding an LED module and the like.

### Solution to Problem

A light-emitting circuit according to an embodiment of the present invention including: a plurality of light-emitting elements configured to emit light; an arrangement member including an arrangement surface on which the plurality of light-emitting elements are arranged; and a substantially cylindrical lamp body including a translucent section at least in a part thereof, including the arrangement member disposed on the inside, and including a projecting body projecting from an inner wall opposed to the arrangement surface and extending toward the arrangement surface.

### Advantageous Effects or Invention

According to the embodiment of the present invention, it can be expected that the lamp body is formed as a straight tube in a stable shape by the projecting body and an LED module and the like are appropriately housed and held.

### BRIEF DESCRIPTION OF DRAWINGS

FIG. 1 is a perspective view showing a luminaire according to a first embodiment of the present invention.

FIG. 2 is a side view showing the luminaire.

FIG. 3 is a perspective view showing a part of a light-emitting circuit (a fluorescent lamp-type light-emitting element lamp) and is a schematic sectional view taken along line X-X in FIG. 1.

FIG. 4 is a longitudinal sectional view showing the light-emitting circuit (the fluorescent lamp-type light-emitting element lamp).

FIG. 5 is a sectional view taken along line Y-Y in FIG. 4.

FIG. 6 is a plan view showing a light source section in the light-emitting circuit viewed from a front surface side.

FIG. 7 is a schematic sectional view taken along line Y-Y in FIG. 6.

FIG. 8 is a schematic sectional view taken along line X-X in FIG. 6.

FIG. 9 is a connection diagram showing the luminaire.

FIG. 10 shows a light-emitting circuit according to a second embodiment of the present invention, wherein (a) is a cross-sectional view, (b) is a partial longitudinal sectional view, and (c) is a plan partial sectional view.

FIG. 11 shows a light-emitting circuit according to a third embodiment of the present invention, wherein (a) is a cross-sectional view, (b) is a partial longitudinal sectional view, and, (c) is a plan partial sectional view.

FIG. 12 shows a light-emitting circuit according to a fourth embodiment of the present invention, wherein (a) is a cross-sectional view, (b) is a partial longitudinal sectional view, and (c) is a plan partial sectional view.

FIG. 13 is a cross-sectional view showing a light-emitting circuit according to a fifth embodiment of the present invention.

FIG. 14 is a cross-sectional view showing a light-emitting circuit according to a sixth embodiment of the present invention.

FIG. 15 is a cross-sectional view showing a light-emitting circuit according to a seventh embodiment of the present invention.

FIG. 16 is a cross-sectional view showing an action of a light guide path for light by the right-emitting circuit according to the fourth embodiment of the present invention.

FIG. 17 shows the light-emitting circuit according to the fourth embodiment of the present invention, wherein (a) is a cross-sectional view and (b) is a plan partial sectional view.

FIG. 18 is a front view showing a luminaire according to an eighth embodiment of the present invention.

FIG. 19 is a perspective view showing a main part of a light-emitting circuit according to the eighth embodiment of the present invention.

FIG. 20 is a partially cut-away perspective view showing the light-emitting circuit according to the eighth embodiment of the present invention.

FIG. 21 is a sectional view in a direction orthogonal to the longitudinal direction of a tube in a light-emitting circuit according to a ninth embodiment of the present invention.

FIG. 22 is a sectional view in a direction orthogonal to the longitudinal direction of a tube in a light-emitting circuit according to a tenth embodiment of the present invention.

FIG. 23 is a sectional view in a direction orthogonal to the longitudinal direction of a tube in a light-emitting circuit according to an eleventh embodiment of the present invent ion

FIG. 24 is a sectional view in a direction orthogonal to the longitudinal direction of a tube in a light-emitting circuit according to a twelfth embodiment of the present invention.

FIG. 25 is a plan view showing a first embodiment of a printed circuit board used in embodiments of a fluorescent lamp-type LED lamp of the present invention.

FIG. 26 is a plan view showing a second embodiment of the printed circuit board used in the embodiments of the fluorescent lamp-type LED lamp of the present invention.

FIG. 27 is a plan view showing a third embodiment of the printed circuit board used in the embodiments of the fluorescent lamp-type LED lamp of the present invention.

### DESCRIPTION OF EMBODIMENT

In the light-emitting circuit according to the embodiment of the present invention, the lamp body is divided into two along the longitudinal direction and the projecting body is provided in one of divided members.

In the light-emitting circuit according to the embodiment of the present invention, the projecting body is a supporting plate set in contact with a surface on the rear side of the arrangement surface in the arrangement member, i.e., a surface on which the light-emitting elements are not provided.

In the light-emitting circuit according to the embodiment of the present invention, the plurality of light-emitting elements are disposed along the longitudinal direction of the lamp body, and the projecting body is provided along, the longitudinal direction of the lamp body having a substantial cylindrical shape and is arranged on a side of the plurality of light-emitting elements.

In the light-emitting circuit according to the embodiment of the present invention, the projecting body includes an end face opposed to the arrangement surface of the arrangement member, and light emitted from the light-emitting element is made incident on the insides of the projecting body and the lamp body, whereby the lamp body functions as a light guide path.

A luminaire according to an embodiment of the present invention including: a light-emitting circuit including a plurality of light-emitting elements configured to emit light, an arrangement member including an arrangement surface on which the plurality of light-emitting elements are arranged, and a substantially cylindrical lamp body including a translucent section at least in a part thereof, including the arrangement member disposed on the inside, and including a projecting body projecting from an inner wail opposed to the arrangement surface and extending toward the arrangement surface; and a luminaire main body in which the light-emitting circuit is disposed.

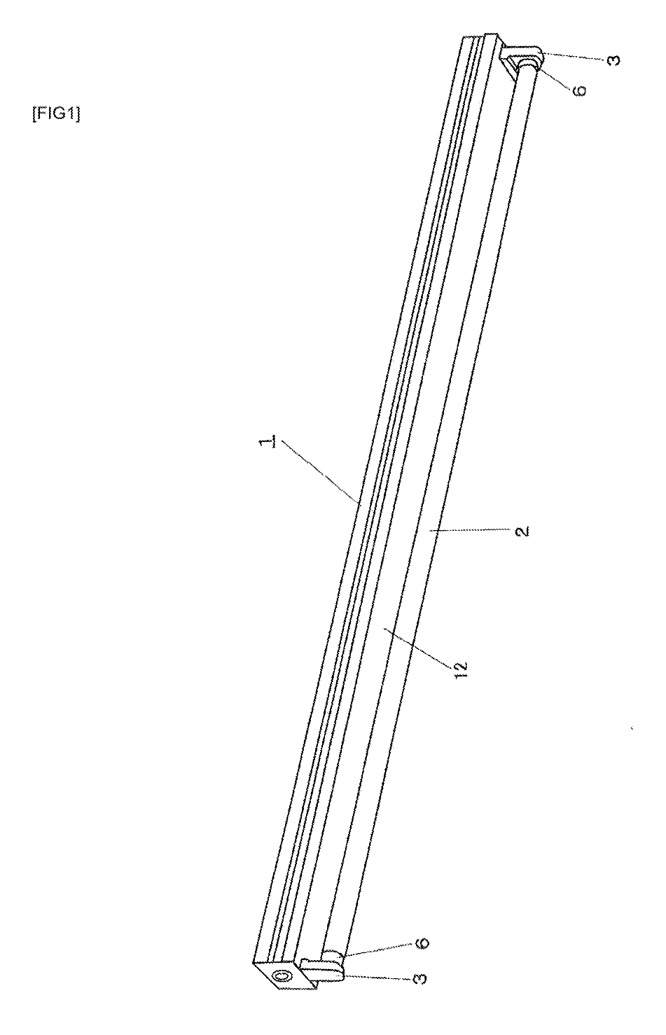

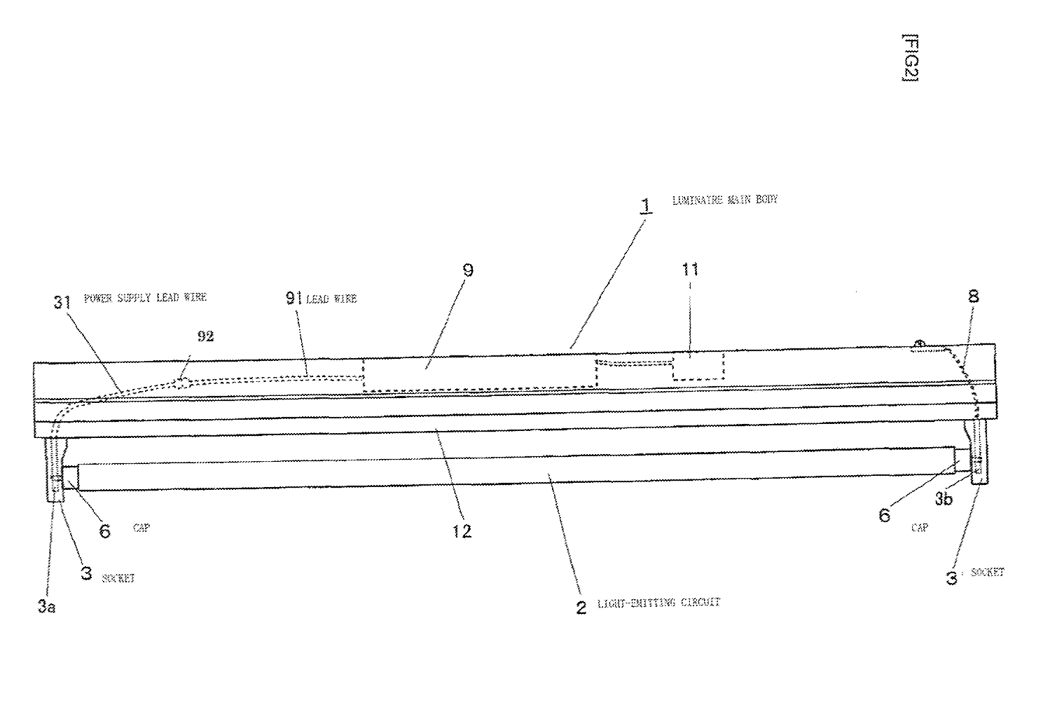

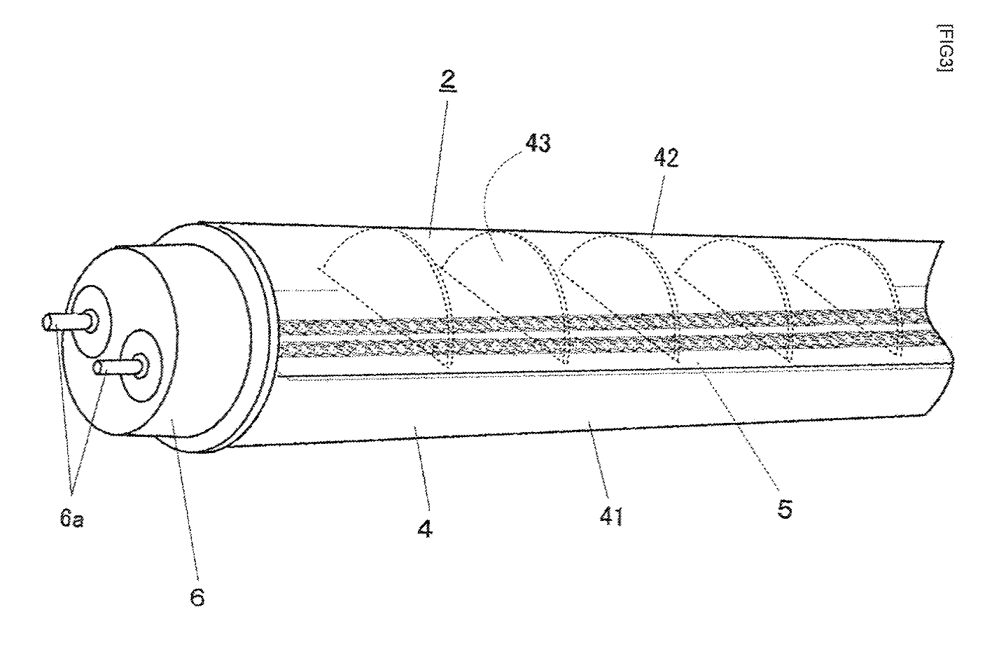

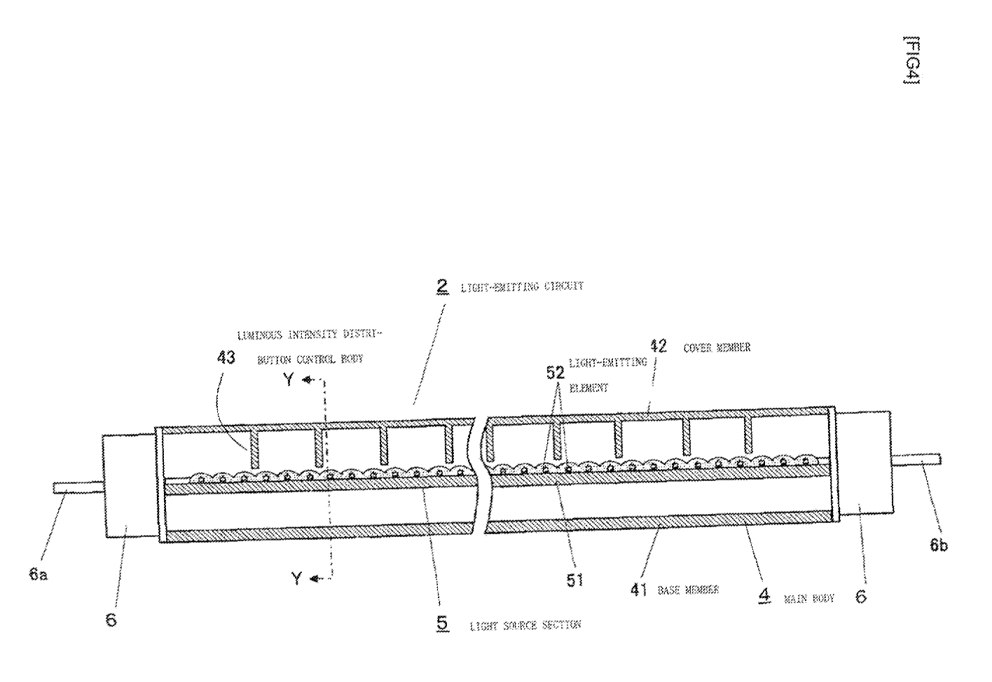

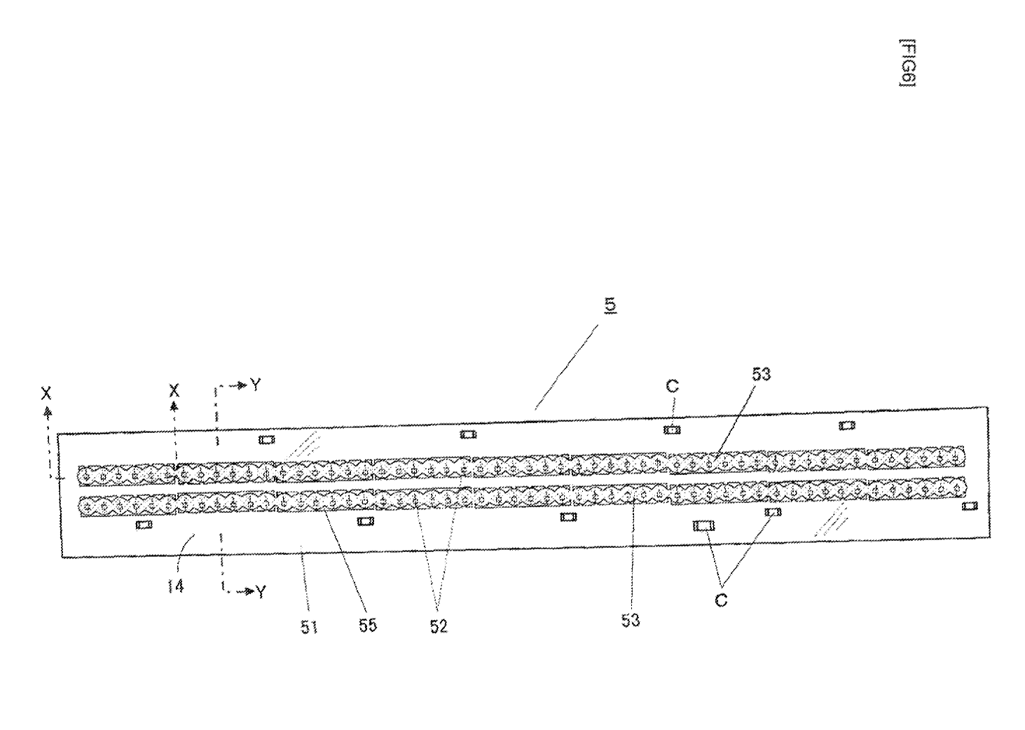

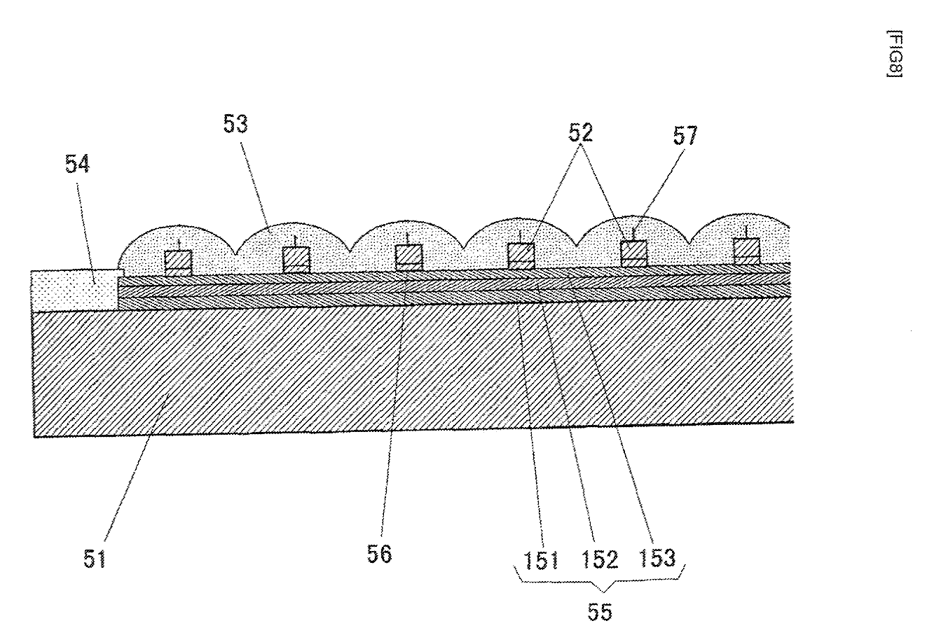

Embodiments of the present invention are explained below with reference to the figures. In the figures, the same components are denoted by the same reference numerals and signs and redundant explanation of the components is omitted. First, first embodiment of the present invention is explained with reference to FIGS. 1 to 9. FIGS. 1 and 2 show a luminaire. FIGS. 3 to 5 show a fluorescent lamp-type light-emitting element lamp functioning as a light-emitting circuit. FIGS. 6 to 8 show a light source section in the fluorescent lamp-type light-emitting element lamp. FIG. 9 shows a connection diagram of the luminaire.

In FIGS. 1 and 2, a luminaire set on a ceiling surface is shown. The luminaire includes a luminaire main body 1 having a laterally long and substantially parallelepiped shape formed by a cold rolled steel sheet or the like and a fluorescent lamp-type light-emitting element lamp 2 functioning as a light-emitting circuit attached to the luminaire main body 1. The luminaire main body 1 is basically formed in the existing configuration. The fluorescent lamp-type light-emitting element lamp 2 is inserted into sockets 3 attached to both ends in the longitudinal direction.

As shown in FIGS. 3 to 5, the fluorescent lamp-type light-emitting element lamp 2 has dimensions and an external shape same as those of the existing straight tube type fluorescent lamp. Specifically, the fluorescent lamp-type light-emitting element lamp 2 has dimensions and an external shape same as those of a 40 W straight tube type fluorescent lamp in the following explanation, an example in which a G13 type cap and a socket adapted to the cap are used is explained. However, the fluorescent lamp-type light-emitting element lamp 2 is not limited to this. A fluorescent lamp-type light-emitting element lamp having arbitrary cap and socket shapes can be adopted.

The fluorescent lamp-type light-emitting element lamp 2 includes a slender lamp body 4 having a substantially cylindrical external shape, a light source section 5, and caps 6. A sectional shape with respect to the longitudinal direction of the substantially cylindrical lamp body 4 includes a circle and an ellipse, does not have to be a complete circle or ellipse, and includes shapes obtained by imitating a circle and an ellipse by combining several plane shapes and shapes obtained by deforming parts of the shapes.

The lamp body 4 includes a space on the inside. The lamp body 4 is formed in a substantially cylindrical shape and formed of a synthetic resin material that is translucent and has diffusivity. The lamp body 4 is formed in the substantially cylindrical shape by coupling two members, i.e., a semi-cylindrical base member 41 and a cover member 42, at opening ends thereof. That is, the lamp body 4 is configured by being divided into two along the longitudinal direction. Naturally, like a lamp body 121 explained in eighth and subsequent embodiments, the lamp body 4 may be a substantially cylindrical lamp body not divided into two.

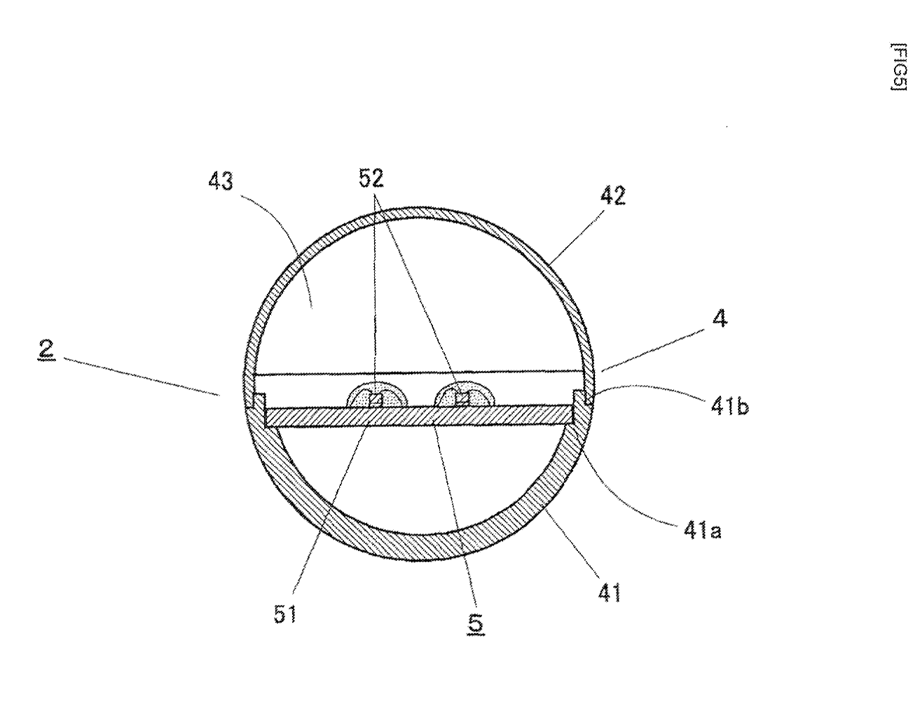

The base member 41 is formed slightly thick compared with the cover member 42. Supporting step sections 41a that support the light source section 5 are formed on the inner sides of the opening ends. Coupling step sections 41b to which the opening ends of the cover member 42 are coupled are formed on the outer sides of the opening ends (see FIG. 5).

On the inner side of the cover member 42, a plurality of semi-circular louvers 43 functioning as projecting bodies are formed in a direction orthogonal to the longitudinal direction to project from an inner wall of the cover member 42. The louvers 43 are provided at substantially equal intervals along the longitudinal direction of the lamp body 4, i.e., the cover member 42 and formed integrally with the cover member 42. Therefore, the louvers 43 are also configured to be translucent and have diffusivity.

The base member 41 may be formed of a non-translucent material and only the cover member 42 opposed to a light-emitting surface of the light source section 5 may be formed of a translucent material. In this case, it is desirable to configure the base member 41 and the cover member 42 to secure, for a portion having translucency, at least 40% or more and preferably 70% or more in the surface area in the circumferential direction of the base member 41 and the cover member 42. Consequently, it is possible to properly secure an area opposed to the light-emitting surface of the light source section 5 and configured to transmit light and emit the light outward without excessively narrowing the area.

As shown in FIGS. 6 to 8, the light source section 5 includes a substrate 51, a plurality of light-emitting elements 52 mounted on the substrate 51, and a phosphor layer 33 that covers the light-emitting elements 52. In the lamp body 4, four substrates 51 are disposed side by side in the longitudinal direction.

The substrate 51 is formed of a glass epoxy resin insulative material and formed in a slender rectangular shape. The length dimension of the substrate 51 is 200 mm and the width dimension of the substrate 51 is 27 mm. The thickness dimension of the substrate 51 is preferably equal to or larger than 0.5 mm and equal to or smaller than 1.8 mm. In this embodiment, a substrate having thickness of 1 mm is applied.

The shape of the substrate 51 is not limited to the rectangular shape. Substrates having a square shape and a circular shape can be applied. As the material of the substrate 51, a glass epoxy substrate (FR4), a glass composite substrate (CEM-3) or other synthetic resin materials relatively inexpensive and having low thermal conductivity can be applied. However, the present invention does not prevent, in improving thermal radiating properties of the light-emitting elements 52, the application of a base substrate made of metal in which an insulating layer is superimposed on one surface of a base plate having satisfactory thermal conductivity and excellent in thermal radiating properties made of aluminum or the likes.

On the front surface side of the substrate 51, a not-shown power supply connector connected to a power supply side, a connection connector used in connecting a plurality of the light source sections 5, and a capacitor C for preventing mislighting of the light-emitting elements 52 due to superimposition of noise on a lighting circuit are mounted. In this way, the substrate 51 configures an arrangement member including the arrangement surface on which the plurality of light-emitting elements 52 are arranged.

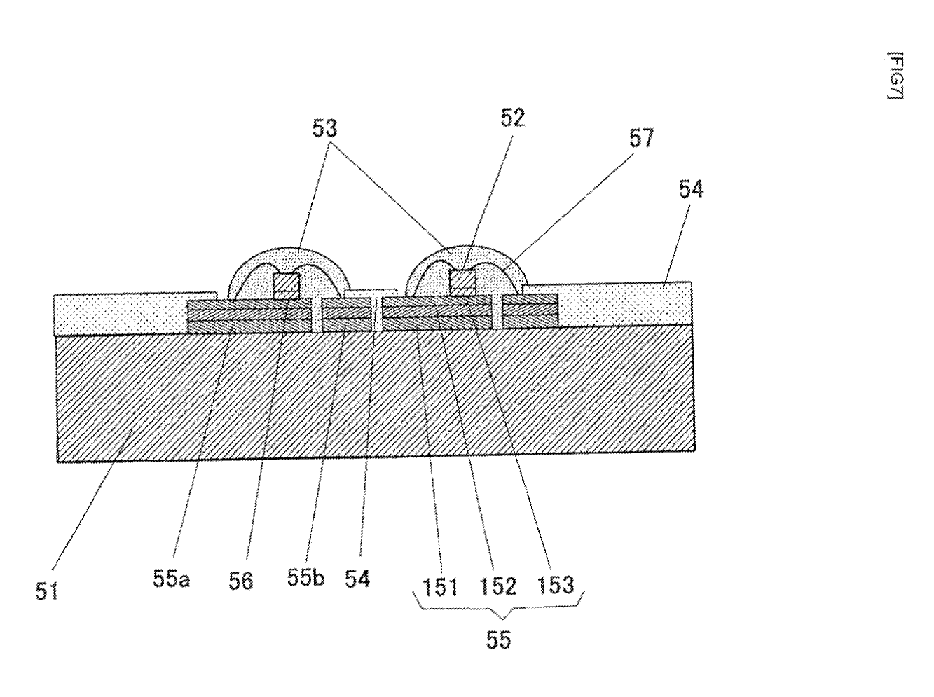

As shown in FIGS. 7 and 8, a; wiring pattern 55 is formed on the substrate 51. The wiring pattern 55 includes a plurality of mounting pads 55a arranged in the longitudinal direction on which the plurality of light-emitting elements 52 are disposed and power-supply conductors 55b that electrically connect the mounting pads 55a.

The wiring pattern 55 has a three-layer configuration. Copper (Cu) functioning as a first layer 151 and nickel (Ni) functioning as a second layer 152 are subjected to electrolytic plating on the surface of the substrate 51. As a third layer 153, silver (Ag) having high reflectance is subjected to electrolytic plating In the third layer 153, i.e., the surface layer of the wiring pattern 55, a reflecting layer is formed with silver (Ag) plating applied thereto. Total ray reflectance is as high as 90%.

On the Surface layer of the substrate excluding mounting regions for the light-emitting elements 52 and mounting portions for components, a white resist layer 54 functioning as a reflecting layer having high reflectance is superimposed over substantially the entire surface.

The plurality of light-emitting elements 52 include bare chips of LEDs. As the bare chips of the LEDs, for example, bare chips of LEDs that emit blue light are used in order to cause a light-emitting section to at whitish light. The bare chips of the LEDs are bonded on the mounding pads 55a using a silicone resin insulative adhesive 56. The bare chips of the LEDs are electrically connected onto the wiring pattern 55 by a bonding wire 57.

The plurality of light-emitting elements 52 are arranged in the longitudinal direction to form light-emitting element rows in a plurality of rows. Specifically, the plurality of light-emitting elements 52 form two light-emitting element rows in the longitudinal direction.

The phosphor layer 53 is made of translucent synthetic resin, for example, transparent silicone resin and contains an appropriate amount of a phosphor such as YAG:Ce. The phosphor layer 53 includes a plurality of convex phosphor layers and, in this embodiment, includes a set of convex phosphor layers that cover the respective light-emitting elements 52 for each of the light-emitting elements 52. The convex phosphor layers are formed in a mountain shape and in an arcuate convex shape and continuously formed to extend to the convex phosphor layers adjacent thereto in the skirts thereof. Therefore, the convex phosphor layers are formed in a plurality of rows along the light-emitting element rows, i.e., formed in two rows. The convex phosphor layers cover and seal the light-emitting elements 52 and the bonding wire 57.

The phosphor is excited by light emitted by the light-emitting elements 52 to emit light of a color different from a color of the light emitted by the light-emitting elements 52. In this embodiment in which the light-emitting elements 52 emit blue light, to enable emission of white light, a yellow phosphor that emits yellowish light in a complementary color relation with the blue light is used as the phosphor. As the light-emitting elements 52, an LED package of a surface mounting type or LEDs of a bullet type can be used.

The caps 6 are, for example, G13 type caps. The caps 6 are configured to be attachable to the socket 3 of the luminaire to which the existing straight tube type fluorescent lamp is attached. The caps 6 are provided at both the ends of the lamp body 4. In the cap 6 portions, pairs of terminal pins 6a and 6b are respectively attached to project. The caps 6 are made of metal. The pairs of terminal pins 6a and 6b are configured to be electrically insulated from each other.

As it is seen when FIG. 9 is referred to as well, the pair of terminal pins 6a on one end side (the left side shown in the figure) are connected to the wiring pattern 55 of the substrate 51 and configured to supply electric power to the light-emitting elements 52 via the socket 3. On the other hand, one terminal pin 6b of the pair of terminal pins 6b on the other and side (the right side shown in the figure) is connected to the earth. For example, the one terminal pin 6b is connected to the substrate 51 by a connecting member.

Any one of the pair of terminal pins 6b may be connected to the earth. For example, both of the pair of terminal pins 6b may be connected to the earth. Consequently, when the caps 6 are connected to the sockets 3 the caps 6 are surely connected to the earth even if directivity is not taken into account.

As shown in FIGS. 1 and 2, the luminaire main body 1 is formed in a box shape including an opened section, the lower surface side of which is opened. The luminaire main body 1 includes the sockets 3 attached to both the ends, a lighting circuit 9 and a terminal block 11 housed in the luminaire main body 1, and a reflecting plate 12 attached to cover the opened section on the lower surface side.

The sockets 3 are the existing sockets. The sockets 3 include power -supply terminals 3a and 3b or the like to which the terminal pins 6a and 6b of the fluorescent lamp-type. light -emitting element lamp 2 are connected. A power supply lead wire 31 is connected to the power-supply terminals 3a of the socket 3 on one end side (the left side shown in the figures) in order to supply electric power to the light source section 5 of the fluorescent lamp-type light-emitting element lamp 2. An earth wire 8 is connected to one of the power-supply terminals 3b of the socket 3 on the other end side (the right side shown in the figures) by means of a screw and the like on the luminaire main body 1. Since the luminaire main body 1 is electrically connected to an earth terminal of the terminal block. 11, the luminaire main body 1 is grounded. Therefore, nothing is connected to the other power-supply terminal 3b of the socket 3.

The lighting circuit 9 is connected to a commercial alternating-current power supply AC. The lighting circuit 9 receives the alternating-current power of the commercial alternating-current power supply AC and generates a direct-current output. The lighting circuit 9 is configured by, for example, connecting a smoothing capacitor between output terminals of a full-wave rectifier circuit and connecting a direct-current voltage converting circuit and current detecting means to the smoothing capacitor. A lead wire 91 is led out from the lighting circuit 9. The lead wire 91 is connected from the power supply lead wire 31 to the power-supply terminals 3a of the socket 3 via a connector 92. A power supply line and an earth wire not shown in the figure are connected to the terminal block 11. The lighting circuit 9 is connected to the terminal block 11 by a lead wire.

The reflecting plate 12 includes a reflection surface. The reflecting plate 12 is attached to cover the opened section on the lower surface side of the luminaire main body 1. At both ends in the longitudinal direction of the reflecting plate 12, substantially rectangular cutout sections in which the sockets 3 fit are formed.

As shown in the connection diagram of FIG. 9, the lighting circuit 9 is connected to the commercial alternating-current power supply AC. An output from the lighting circuit 9 is supplied to the light-emitting elements 52. In this case, the output from the lighting circuit 9 is supplied from the socket 3 to the substrate 51 and the light-emitting elements 52 via the pair of terminal pins 6a of the cap 6. On the other hand, one terminal pin 6b of the terminal pins 6b of the cab 6 on the other end side is connected to the earth via the socket 3.

In the luminaire configured as explained above, when electric power is supplied to the lighting circuit 9, electricity is conducted from the lead wire 91, the power supply lead wire 31, the socket 3, and the cap 6 to the light-emitting elements 52 via, the substrate 51. The light-emitting elements 52 emit light. The light emitted from the light-emitting elements 52 is transmitted through the translucent lamp body 4 and emitted downward. A predetermined range is irradiated by the light.

In this case, the light emitted from the light-emitting elements 52 does not draw near to the luminaire side. Luminous intensity distribution control for, for example, suppressing glare can be performed by the louvers 43 provided in the light-emitting circuit, i.e., the fluorescent lamp-type light-emitting element lamp 2. Therefore, luminous intensity distribution control of the fluorescent lamp-type light-emitting element lamp 2 alone can be performed. Desired luminous intensity distribution control is easily performed. Therefore, an effect that luminous intensity distribution control means on the luminaire side can be omitted or simplified can also be expected.

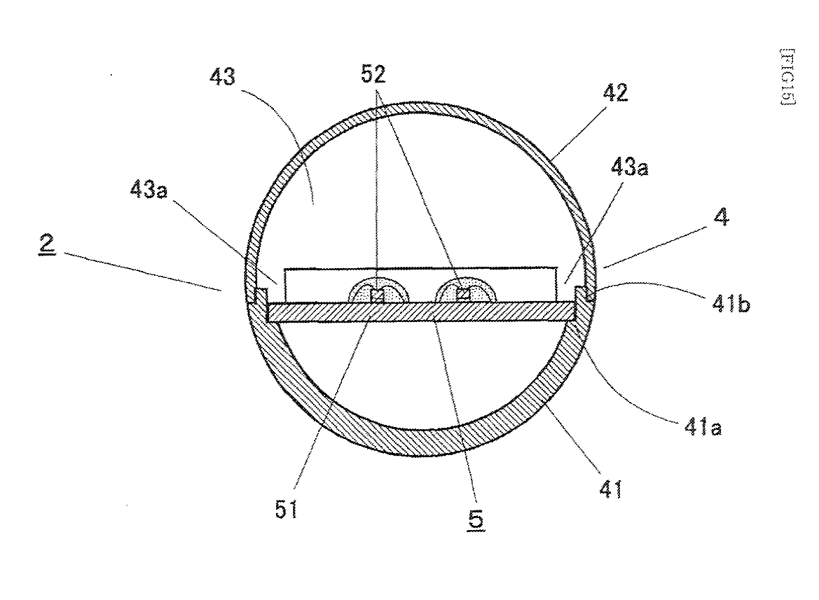

The louvers 43, which are projecting bodies, project from the inner wall of the lamp body 4 opposed to the arrangement surface of the substrate 51 functioning as the arrangement member and extend toward the arrangement surface. Therefore, the lamp body 4 can be formed as a straight tube in a stable shape by the louvers 43. It can be expected that an LED modules and the like can be appropriately housed and held. Since the louvers 43 are translucent and has diffusivity, an effect that the light emitted from the light-emitting elements 52 is diffused and variance in brightness of the light source section 5 is reduced can be realized. In particular, as shown in FIG. 16, the louvers 43, which are the projecting bodies, include end faces 43E opposed to the arrangement surface on which the light-emitting elements 52 are provided in the substrate 51 functioning as the arrangement member. The light emitted from the light-emitting elements 52 are made incident on the inside of the lamp body 4 itself from the end faces 43E via the inside of the louvers 43 themselves, whereby the lamp body 4 (the cover member 42) functions as a light guide path. According to the diffusivity of the lamp body 4, when viewed from the outside of the lamp body 4 the entire lamp body 4 shines as if the lamp body 4 is emitting light. It is possible to reduce variance in brightness of the light source section 5.

As explained above, according to this embodiment, the fluorescent lamp-type light-emitting element lamp 2 compatible with the existing fluorescent lamp in terms of structure can be applied and can be formed as a straight tube in a stable shape by the projecting bodies. Further, it is possible to provide a light-emitting circuit and a luminaire in which desired luminous intensity distribution control is easily obtained.

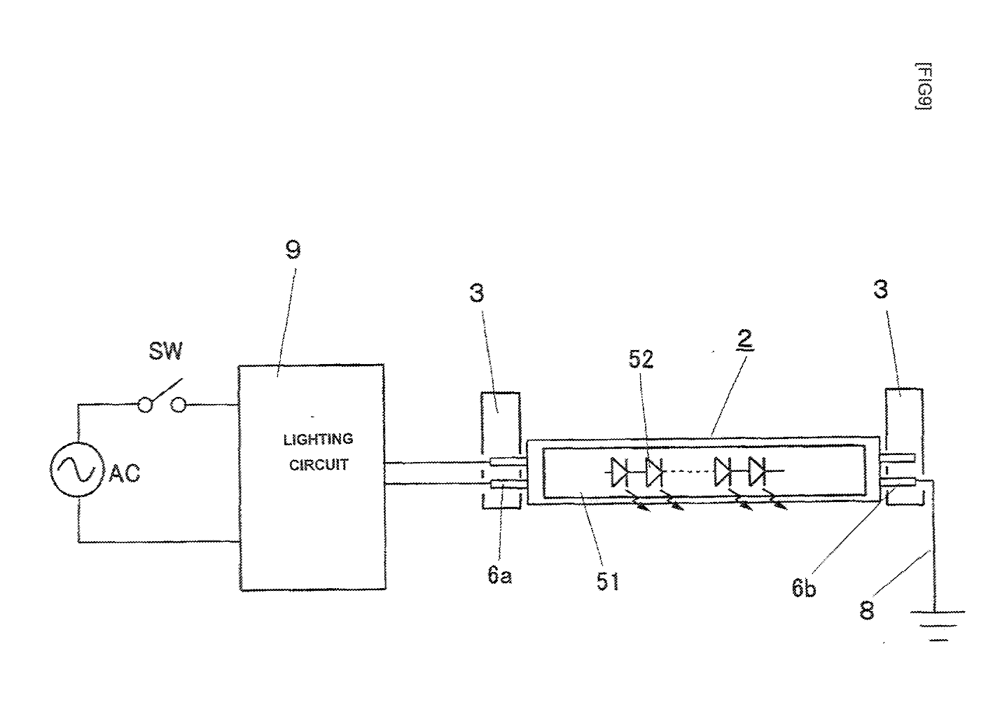

The fluorescent lamp-type light-emitting element lamp 2 may be a fluorescent lamp-type light-emitting element lamp incompatible with the existing fluorescent, lamp in terms of structure. For example, the fluorescent lamp-type light-emitting element lamp 2 may include caps exclusive for the fluorescent lamp-type light-emitting element lamp 2 and include, on the luminaire side, sockets adapted to the caps. The arrangement member is not limited to the substrate 51 on which the light-emitting elements 52 are directly arranged. The arrangement member includes a member such as a thermal radiating structure mounted in the lamp body 4 with the light-emitting elements 52 indirectly arranged thereon. A second embodiment of the present invention is explained with reference to FIG. 10. Components acme as or equivalent to the components in the first embodiment are denoted by the same reference numerals and signs and redundant explanation of the components is omitted.

In this embodiment, an LED package of a surface mounting type is used as the light-emitting elements 52. A plurality of the LED packages are mounted on the substrate 51. The LED package of the surface mounting type schematically includes an LED chip disposed in a main body formed of ceramics and molding translucent resin such as epoxy resin or silicone resin for sealing the LED chip.

The LED chip is a blue LED chip that emits blue light. A phosphor is mixed in the translucent resin. To enable emission of white light, a yellow phosphor that emits yellowish light in a complementary color relation with the blue light is used as the phosphor.

The configuration of the louvers 43 functioning as the projecting bodies is the same as the configuration in the first embodiment. However, the louvers 43 are arranged to individually partition the light-emitting elements 52. Therefore, it is possible to precisely perform luminous intensity distribution control by the louvers 43. A lamp body can be formed as a straight tube in a stable shape by the louvers 43.

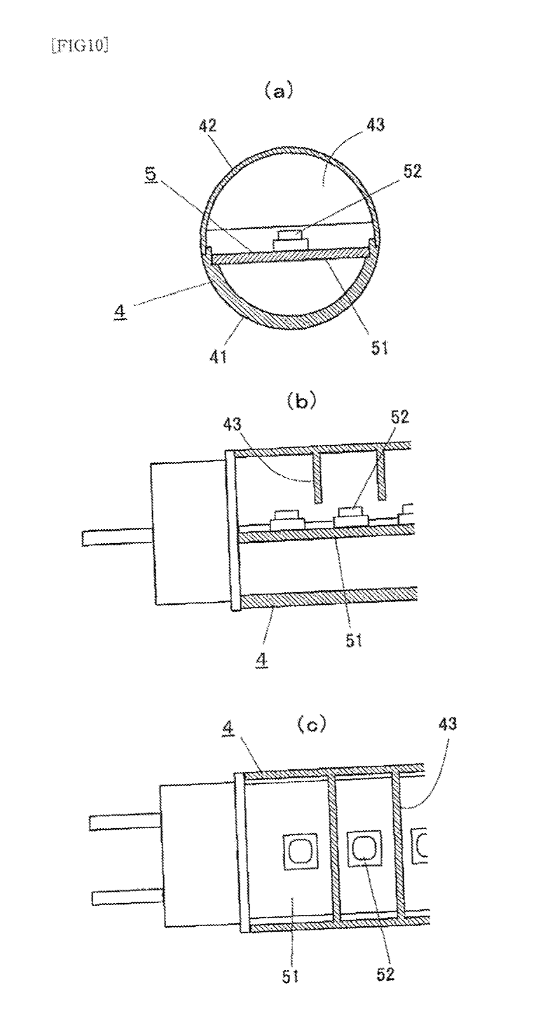

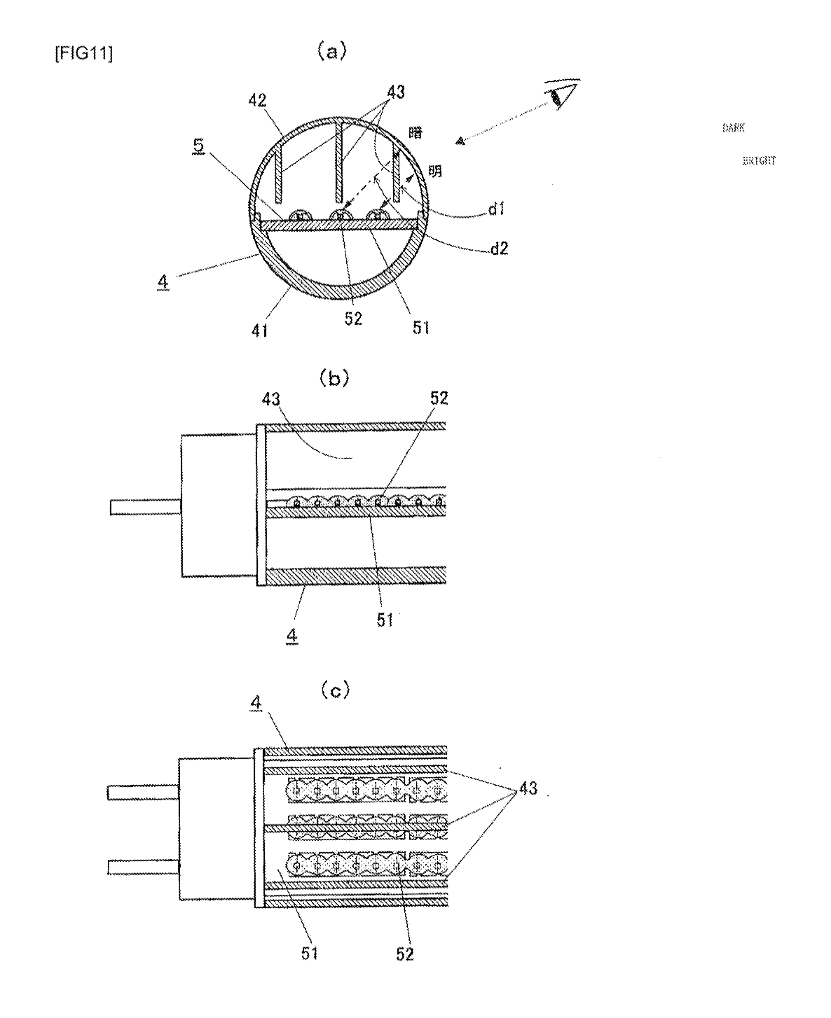

A third embodiment of the present invention is explained with reference to FIG. 11. Components same as or equivalent to the components in the first embodiment are denoted by the same reference numerals and signs and redundant explanation of the components is omitted.

In this embodiment, as in the first embodiment, bare chips of LEDs are used as the light-emitting elements 52. Light-emitting element rows in three rows are formed in the longitudinal direction of the substrate 51.

Three louvers 43 functioning as the projecting bodies are linearly formed along the longitudinal direction. With such a configuration, it is possible to mainly reduce glare and reduce a luminous intensity distribution angle

For example, as shown in FIG. 11(a), a distance d1 from the light-emitting element 52 located in a side portion of the substrate 51 to the cover member 42 and a distance d2 from the light-emitting element 52 located in the center of the substrate 51 to the cover member 42 are different. The distance d1 is relatively short and the distance d2 is relatively large. The distances d1 and d2 are in a relation of d2>d1. In this case, if the louvers 43 are not provided, when the fluorescent lamp-type light-emitting element lamp 2 is viewed from a side, a region of the cover member 42 corresponding to the light emitting element 52 located in the side portion of the substrate 51 is bright and a region of the cover member 42 corresponding to the light-emitting element 52 located in the center of the substrate 51 is dark. Therefore, light and shade tend to appear.

Such a tendency can be suppressed by increasing the diffusivity of the cover member 42 and the louvers 43. However, when the diffusivity is increased, deterioration in efficiency of light emitted outward from the cover member 42 is caused.

In this embodiment, the louvers 43 functioning as the projecting bodies are arranged along the longitudinal direction and to be located on a side of the light-emitting elements 52. Therefore, it is possible to reduce the appearance of light and shade while maintaining predetermined diffusivity (maintaining transparency) of the cover member 42, i.e., while maintaining efficiency. The lamp body can be formed as a straight tube in a stable shape by the louvers 43 functioning as the projecting bodies. As the light-emitting elements 52, an LED package of a surface mounting type can be used.

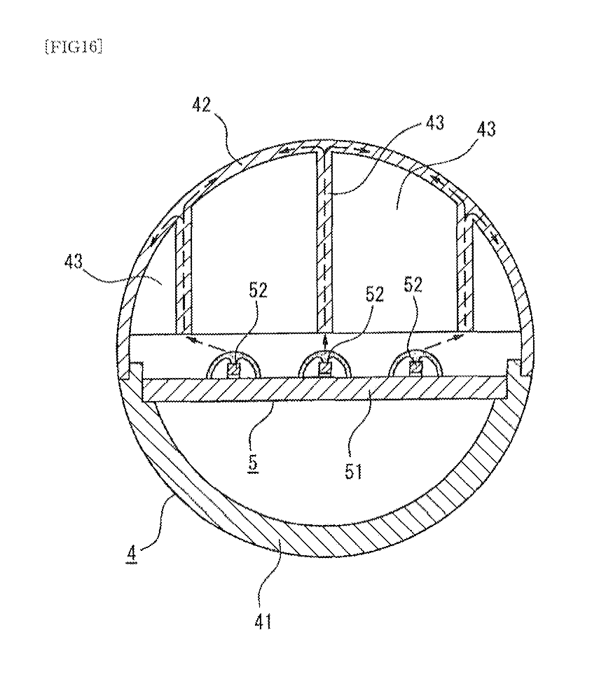

In an embodiment including a configuration in which a plurality of the substrates 51 are provided in the lamp body 4 and the substrates 51 are connected by connectors CN as shown in FIG. 17, the effect of reducing the appearance of light and shade is realized concerning the connectors CN as well. If the louvers 43 are not provided, light emitted from the light-emitting elements is blocked by the connectors CN and shadows of the connectors CN are formed in side portions of the lamp body 4 in positions where the connectors CN are mounted. On the other hand, as shown in FIGS. 17(a) and 17(b), the connectors CN are provided further on the inner side than the louvers 43 (an extended line of the ends 43E in the louvers 43). Consequently, when light emitted from the light-emitting elements 52 reaches the louvers 43 provided on the side portions of the lamp body 4 in the positions where the connectors CN are mounted, the light is diffused and transmitted by the louvers 43 to make the shadows of the connectors CN faint. Further, as explained with reference to FIG. 16, since the lamp body 4 functions as the light guide path, concerning the positions where the connectors CN are mounted, it is possible to reduce the appearance of light and shade viewed from the side portions of the lamp body 4.

Subsequently, a fourth embodiment of the present invention is explained with reference to FIG. 12. Components same as or equivalent to the components in the first embodiment are denoted by the same reference numerals and signs and redundant explanation of the components is omitted.

In this embodiment, the louvers 43 functioning as the projecting bodies are formed in the longitudinal direction and a direction orthogonal to the longitudinal direction and formed in a lattice shape.

In this configuration, a luminous intensity distribution control function by the louvers 43 is intensified. It is possible to reduce glare and reduce a luminous intensity distribution angle.

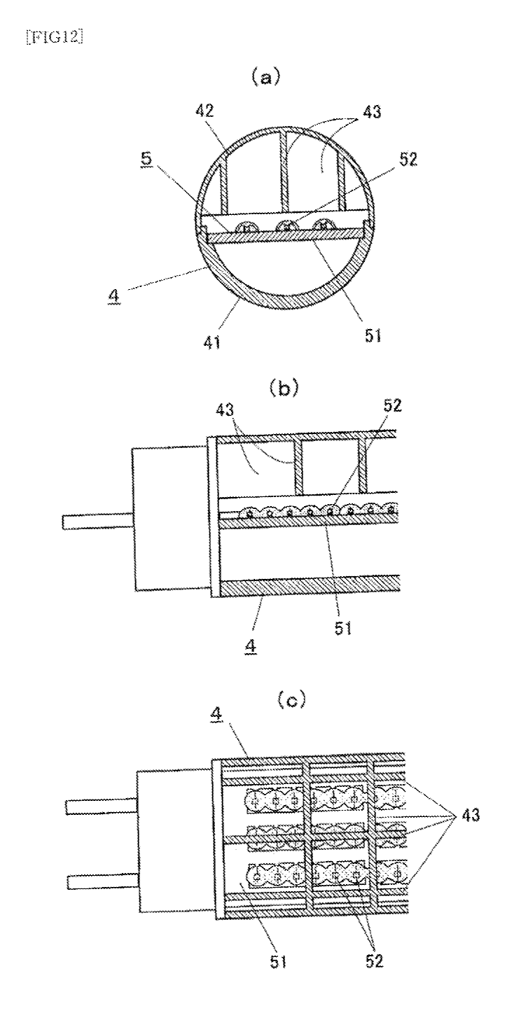

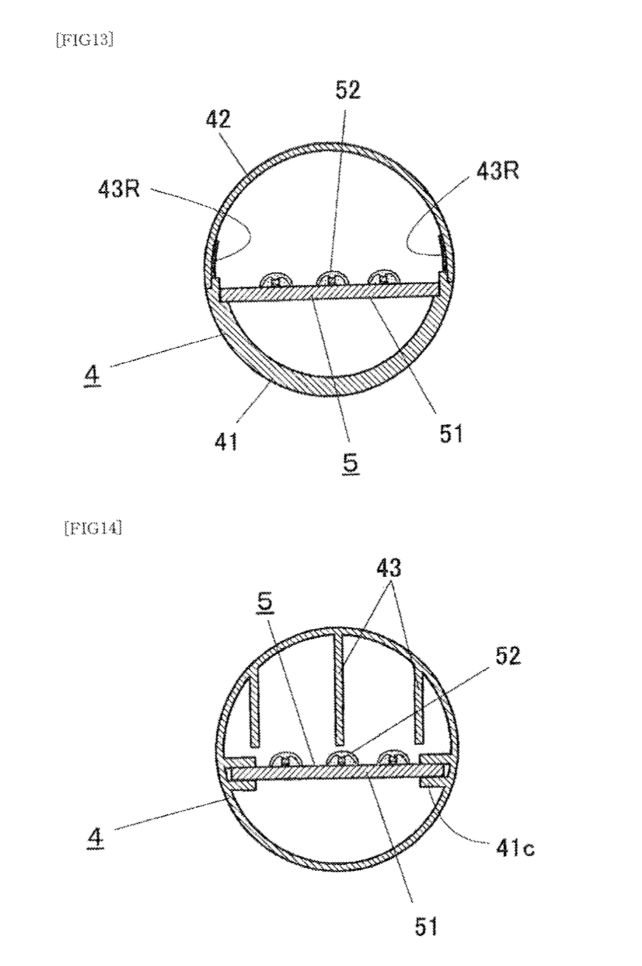

A fifth embodiment of the present invention is explained with reference to FIG. 13. Components same as or equivalent to the components in the first embodiment are denoted by the same reference numerals and signs and redundant explanation of the components is omitted.

In this embodiment, reflecting layers 43R are formed as projecting bodies along the longitudinal direction in the vicinities of both opened ends of the cover member 42. Consequently, light emitted from the light-emitting elements 52 is blocked at a predetermined angle and subjected to luminous intensity distribution control. Therefore, it is possible to reduce glare.

A sixth embodiment of the present invention is explained with reference to FIG. 14. This embodiment is substantially the same as the third embodiment. However, the configuration of the substantially cylindrical lamp body 4 is different.

The lamp body 4 includes an internal space. The lamp body is integrally formed in a substantially cylindrical shape by extrusion molding. A pair of supporting protrusions 41c, which support the substrate 51, are formed to be opposed to each other in substantially the center on the inner surface side of the lamp body 4. The supporting protrusions 41c are formed in a rail shape along the longitudinal direction of the lamp body 4.

In this way, the lamp body 4 can be integrally formed. In this case, a molding method is not particularly limited.

Subsequently, a seventh embodiment of the present invention is explained with reference to FIG. 15. In this embodiment, configuration is substantially the same as the configuration in the first embodiment. This embodiment is different from the first embodiment in that contact sections 43a in contact with the front surface of the substrate 51 are formed at both ends in the louvers 43 functioning as the projecting bodies.

With such a configuration, it is possible to press the substrate 51 with the contact sections 43a of the louvers 43 and hold the substrate 51 in the lamp body 4. Therefore, the louvers 43 functioning as the projecting bodies can include both a function of luminous intensity distribution control and a function of holding the substrate 51.

The substrate 51 can be held in the lamp body 4 simultaneously with the base member 41 and the cover member 42 being coupled. Therefore, the configuration and assembly work can be simplified.

In this case, this embodiment does not prevent means such as screwing from being applied in order to make it sure to hold the substrate 51. Further, the contact sections 43a may be provided in all of the plurality of louvers 43 or may be provided in specific several louvers 43.

The present invention is not limited to the configurations of the embodiments. Various modifications are possible without departing from the spirit of the present invention. In the embodiments, the fluorescent lamp-type light-emitting element lamp including the caps is explained as the light-emitting circuit. However, the light-emitting circuit is not limited to this. For example, the light-emitting circuit can be configured as a light-emitting circuit not including caps. In this embodiment, luminous intensity distribution control can be performed by the projecting bodes provided in the light-emitting circuit. Therefore, the light-emitting circuit alone can perform the luminous intensity distribution control. An intended effect that desired luminous intensity distribution control is easily performed can be expected. The projecting bodies may be subjected to specular finishing treatment or may be applied with white reflective painting so as to obtain a high reflectivity. The projecting bodies can be configured as appropriate in order to perform desired luminous intensity distribution control.

The light-emitting elements mean solid-state light-emitting elements such as LEDs or organic ELs. A mounting method for the light-emitting elements and the number of light-emitting elements are not particularly limited. As the light-emitting elements, light-emitting elements having light emission colors such as red, green, or blue can be applied. Further, concerning a luminaire, the light-emitting elements can be applied to a luminaire, a display apparatus, and the like used indoors or outdoors.

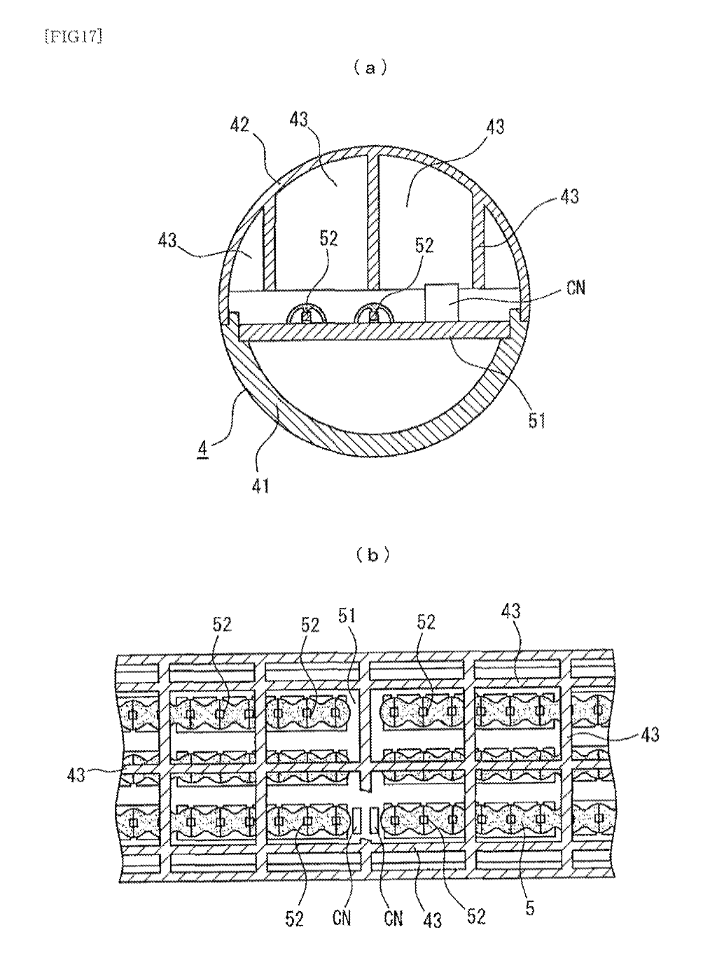

A light-emitting circuit and a luminaire according to an eighth embodiment are explained. FIG. 18 is a front view o a luminaire 110 according to this embodiment. In a luminaire main body 111, a lighting circuit 118, which is a power supply source, is provided and sockets 112, 112 projecting from both ends in a housing of the luminaire 110 are provided. A fluorescent lamp-type light-emitting element lamp 120, which is a light-emitting circuit, has a configuration in which caps 124, from which power-supply terminals 122 and supporting terminals 123 project to the outer sides, are provided at both ends of an elongated tube-like lamp body 121.

The lighting circuit 118 creates a direct-current power necessary for the fluorescent lamp-type light-emitting element lamp 120 to light and supplies a voltage to two receiving terminals 114 included in one socket 112 via a power supply line 113. The power-supply terminals 122 are two terminals to correspond to the two receiving terminals 114. When the power-supply terminals 122 and the two receiving terminals 114 are connected, necessary electric power is supplied to the fluorescent lamp-type light-emitting element lamp 120. The supporting terminals 123 are inserted into and engaged with engaging holes 115 provided in the socket 112 on a side opposed to the receiving terminals 114. Consequently, the fluorescent lamp-type light-emitting element lamp 120 is attached to and mounted on the luminaire main body 111. A connection configuration for the sockets 112, the terminals 122 and 123, and the lighting circuit 118 may be the configuration shown in FIGS. 1 to 9.

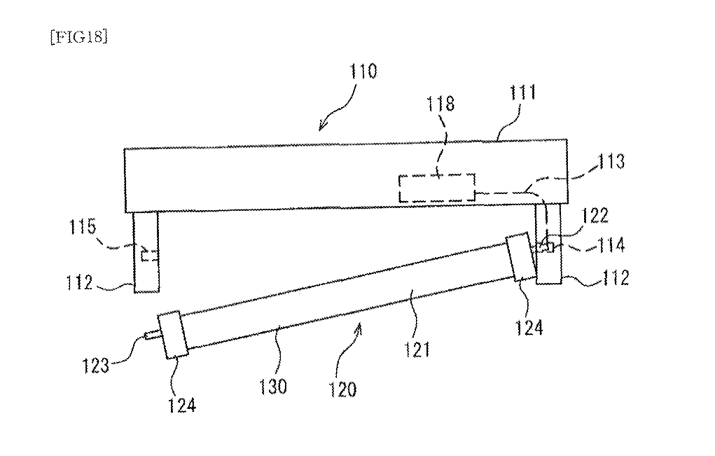

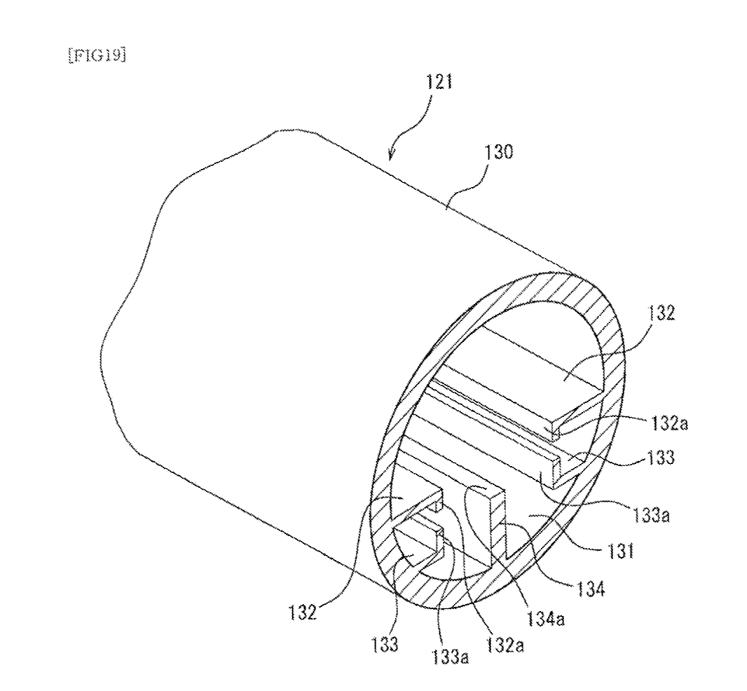

The fluorescent lamp-type light-emitting element lamp 120 according to the eighth embodiment is a configuration in which the lamp body 121 of a tube 130 made of resin is used as shown in FIGS. 19 and 20. Naturally, as in the first embodiment, the lamp body 121 may be divided into two along the longitudinal direction. A sectional shape of the tube 130 in a direction orthogonal to the longitudinal direction is a circular shape. At least a part of the tube 130 has translucency. On an inner wall 131 of the tube 130, in a position closer to the inner wall 131 side than the center of the tube 130, holding means for holding a substrate 4 functioning as an arrangement member in a state in which the light-emitting elements 52 are directed to the outer side is formed by extrusion molding.

The substrate 140 is elongated. On one surface of the substrate 140, the plurality of light-emitting elements 52 are mounted in one row or in a plurality of rows at a required interval. The light-emitting elements 52 are buried by a phosphor layer. The configuration of portion is as explained above with reference to FIGS. 1 to 9.

In the eighth embodiment a chord shorter than the diameter of the circular cross section is provided such that L-shaped first clamping plates 132, 132 extend from two positions crossing the inner well 131 to the center direction of the chord. L-shaped second clamping plates 133, 1.33 are provided in parallel to the first, clamping plates 132, 132. The second clamping plates 133, 133 are provided on a circle chord shorter than the circle chord on which the first clamping plates 132, 132 are provided. Distal ends 132a, 132a of the first clamping plates 132, 132 are bent at a right angle to the second clamping plates 133, 133 side. Distal ends 133a, 133a of the second clamping plates 133, 133 are bent at a right angle to the first clamping plates 132, 132 side. The distal ends 132a, 132a and the distal ends 133a, 133a are opposed to each other. The first clamping plates 132, 132 and the second clamping plates 133, 133 are continuously formed from one end to the other end in the longitudinal direction in the tube 130. The vicinities of the long two sides of the substrate 140 are clamped by slits formed between the distal ends 132a, 132a and the distal ends 133a, 133a.

On a diameter orthogonal to the circle chord, an elongated streak of supporting plate 134 is continuously formed from one end to the other and in the longitudinal direction of the inner wall in the tube 130. The supporting plate 134 functioning as a projecting body projects from the inner well 131 close to the second clamping plates 133, 133 and extends on the rear surface side toward the arrangement surface of the light-emitting elements 52. A head 134a comes into contact with one surface (the rear surface of the arrangement) of the substrate 140 to support the substrate 140. The substrate 140 comes into contact with the supporting plate 134 on a surface on which the light-emitting elements 52 are not provided. When the substrate 140 is supported, the-substrate 140 is kept in a flat state. In this embodiment, the substrate 140 is clamped. However, a configuration in which the substrate 140 on which the light-emitting elements 52 are arranged is arranged on another member and the member is held in the lamp body 121 may be adopted.

The first clamping: plates 132, 132, the second clamping plates 133, 133, and the supporting plate 134 configure holding means. The holding means may be formed by extrusion molding. The supporting plate 134 may be a streak of member continuous in the longitudinal direction or may be a member on which a plurality of columns project like bosses.

The caps 124 fit in of ends of the tube 130 are formed in a bottomed cylindrical Shape. The power-supply terminals 122 provided in a disk-like lid section 125 pierce through the cap 124 from the outer side to the inner side. For example, distal ends of the piercing power-supply terminals 122 extend to end regions in the first clamping plates 132, 132 in the tube 130 as shown in FIG. 3. The distal ends are connected to a print pattern of the substrate 140 via appropriate means such as connectors.

In the tube 130, usually, a plurality of the substrates 140 are housed side by side. Circuits of the substrates 140 are connected by connecting instruments such as connectors. In this case, when the substrates 140 are supported by the supporting plate 134, the substrates 140 are kept in a flat state. This contributes to appropriate connection. The supporting plate 134 functioning as the projecting body can form the light-emitting circuit as a straight tube in a stable state. As a result, when the substrates 140 are kept in the flat state, this means that the light-emitting elements 52 of the substrates 140 irradiate light in an aligned direction. Am appropriate luminous intensity distribution characteristic of the luminaire is realized.

In FIG. 21, a sectional view in a direction orthogonal to the longitudinal direction of the tube 130 in the fluorescent lamp-type light-emitting element lamp 120 according to a ninth embodiment is shown. In the ninth embodiment, a configuration in which the second clamping plates 133, 133 in the eighth embodiment are removed and the substrate 140 is clamped by the first clamping plates 132, 132 and the supporting plate 134 is adopted. With this configuration, it is possible to obtain an effect same as the effect of the eighth embodiment.

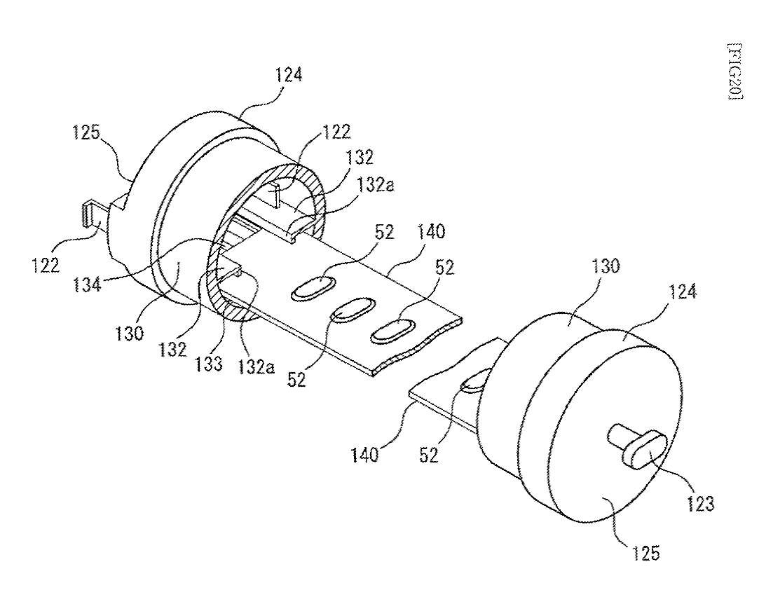

In FIG. 22, a sectional view in a direction orthogonal to the longitudinal direction of the tube 130 in the fluorescent lamp-type light-emitting element lamp 120 according to a tenth embodiment is shown. The shape of the tube 130 is a shape obtained by cutting a part of an arc in a circular shape and changing the tube 130 into is flat plate 135. Clamping pieces 136 for clamping the substrate 140 are formed in regions close to connecting sections of the fiat plate 135 and the arc. The clamping pieces 136 are long in the longitudinal direction like the first clamping plates 132, 132 and are formed by extrusion molding. The shape of the caps 124 is formed according to the sectional shape. With this configuration, it is possible to obtain an effect same as the effect of the eighth embodiment.

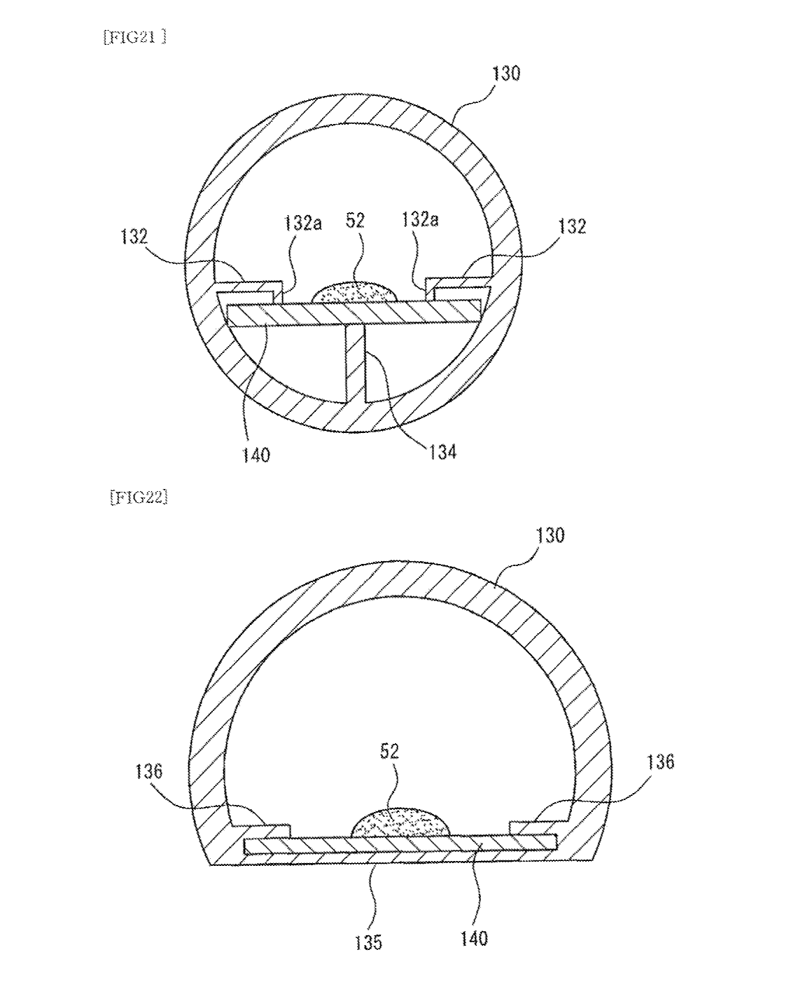

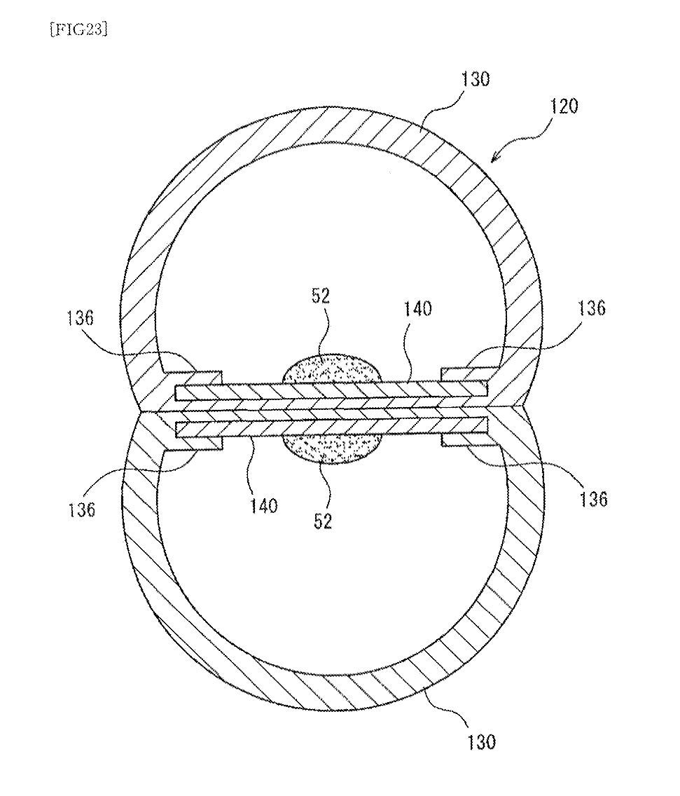

In FIG. 23, a sectional view in a direction orthogonal to the longitudinal direction of the lamp body 121 in the fluorescent lamp-type light-emitting element lamp 120 according to an eleventh embodiment is shown. The lamp body 121 is a lamp body formed by connecting back to back the fiat plates 135 of the tubes 130 in the tenth embodiment shown in FIG. 22. The shame of the cap 124 is formed according to the sectional shape. The light-emitting elements 52 in the tube 130 irradiate light in two directions 180 degrees different from each other. This enables lighting by wider luminous intensity distribution.

In FIG. 24, a sectional view in a direction orthogonal to the longitudinal direction of the lamp body 121 in the fluorescent lamp-type light-emitting element lamp 120 according to a twelfth embodiment is shown. In the tube 130, the flat plate 135 is formed on the diameter of the circle in the cross section of the tube 130. The shape of the cap 124 is formed according to the sectional shape. The light-emitting elements 52 in the tube 130 irradiate light in two directions 180 degrees different from each other. This enables lighting by wider luminous intensity distribution without forming the flat plate 135 on a circle chord shorter than the diameter as shown in FIG. 23.

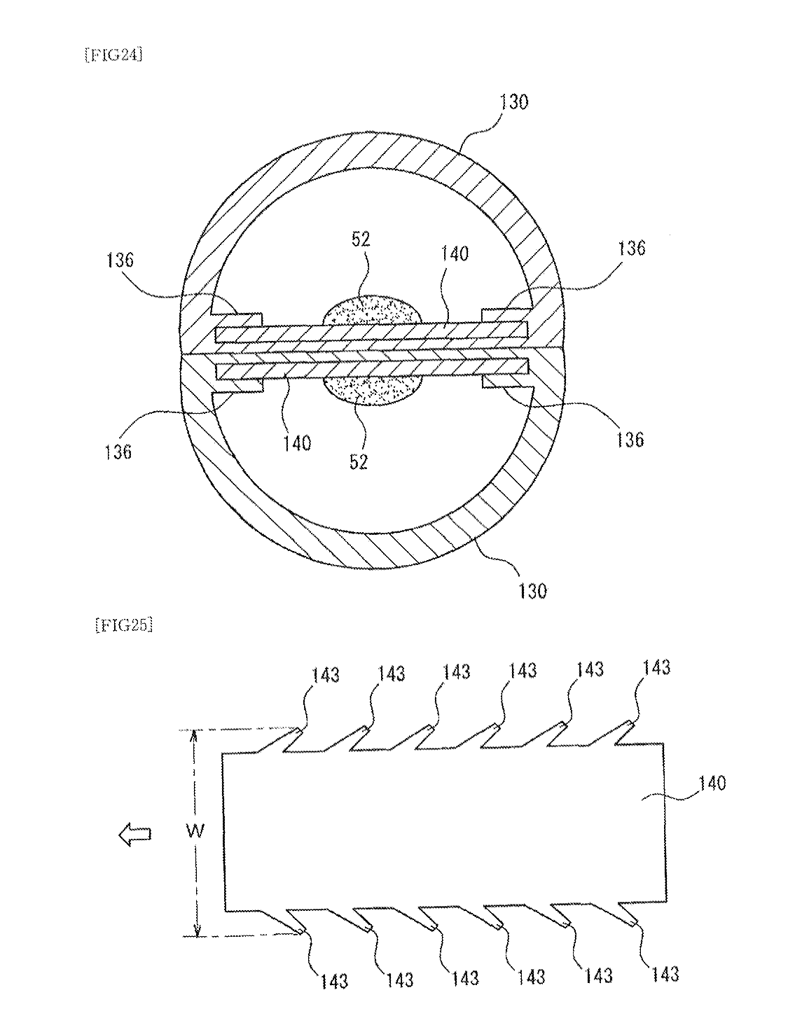

FIG. 25 is a plan view showing a first embodiment of the substrate 140 used in the embodiments of the present invention. On the substrate 140, a plurality of convex pieces 143 are formed at an equal interval on two sides (sides where the clamping plates 132 and the like are formed) in contact with the inner wall of the tube 130. The convex pieces 143 are wide in base portions and configured to be narrowed toward the distal ends. The convex pieces 143 as a whole have an inclined saw tooth shape. Width W of the substrate 140 is formed slightly longer than the length of the circle chord in the tube 130 into which the substrate 140 is inserted.

When the substrate 140 having the configuration explained above is used, when the substrate 140 is inserted into a predetermined position of the tube 130, the convex pieces 143 presses the inner wall 131. Therefore, after the insertion, the substrate 140 is appropriately fixed without wobbling.

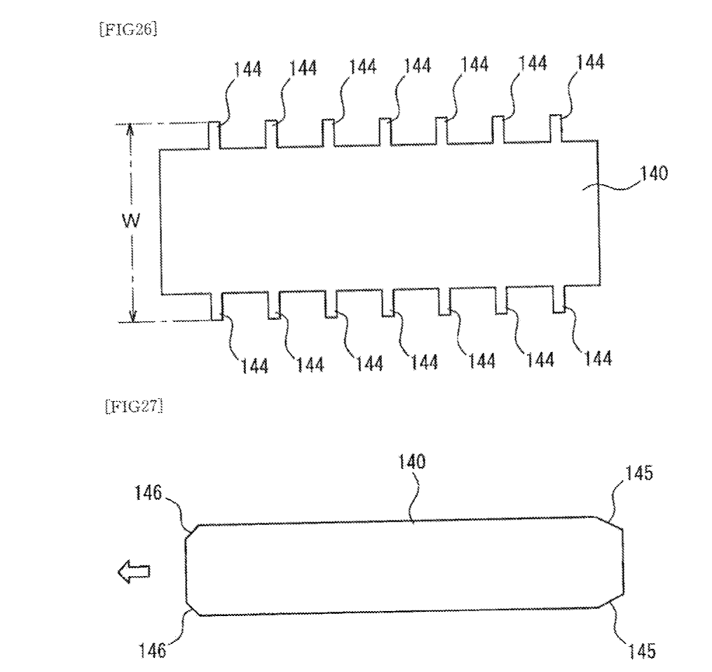

FIG. 26 is a plan view showing a second embodiment of the substrate 140 used in the embodiments of the present invention. Instead of the saw tooth-like convex pieces 143, a plurality of square convex pieces 144 are formed at an equal interval. With this configuration, it is possible to obtain an effect same as the effect of the first embodiment.

In the embodiments shown in FIGS. 25 and 26, the convex pieces 143 and the convex pieces 144 can be formed to horizontally project from the side walls of the substrate 140. The distal ends of the convex pieces 143 and the convex pieces 144 can be formed to be bent upward or downward from the horizontal state. In this case, the distal, ends of all of the convex pieces 143 and the convex pieces 144 may be formed to be bent upward or downward from the horizontal state. However, every predetermined number of the convex pieces 143 and the convex pieces 144 (e.g., every other convex piece 143 and convex piece 144) may be alternately formed to be bent upward and downward from the horizontal state.

FIG. 27 is a plan view shoving a third embodiment of the substrate 140 used in the embodiments of the present invention. The substrate 140 in this embodiment includes identifying means for making it possible to identify the front and the back when the substrate 140 is inserted into a tube. In FIG. 27, two corner sections connected by one short side are cut out large to form cutout sections 145 and two corner sections connected by the other short side are cut out small to form cutout sections 146. The cutout sections 145 and 146 are formed as the identifying means. In this case, for example, as indicated by an arrow, the substrate 140 is inserted into the tube 130 from the side of the short side including the large cutout sections 145. Consequently, it is possible to accurately insert the substrate 140 into the tube. The substrates 140 are not rug connected and are not unable to be connected. Therefore, it is possible to improve work efficiency.

The substrate 140 in the embodiment shown in FIG. 25 also includes identifying means. That is, since the pieces 143 are formed to incline, as indicated by an arrow, the substrate 140 can he decided to be inserted into the tube 130 from the side of the short side, which is a side where an angle formed by the convex pieces 143 and the sidewall of the substrate 140 is an obtuse angle. The substrate 140 in the embodiment shown in FIG. 26 does not include identifying means in the state shown in the figure. However, the convex pieces 143 can be used as the identifying means by gradually changing the interval of the convex pieces 143 along the longitudinal direction or gradually changing the width of the convex places 143 along the longitudinal direction. In both the cases, an effect same as the effect of the embodiment of the substrate 140 shown in FIG. 27 is realized.

### REFERENCE SIGNS LIST

1 luminaire main body

2 light-emitting circuit (fluorescent lamp-type light-emitting element lamp)

3 sockets

4 A main body

6 caps

5 light source section

41 base member

42 cover member

43 louvers (projecting bodies)

43a contact sections

51 substrate (arrangement member)

52 light-emitting elements (LEDs)

110 luminaire

111 luminaire main body

120 lamp

121 lamp body

130 tube

134 supporting plate (projecting body)

140 substrate (arrangement member)

1. A light-emitting circuit comprising:
a plurality of light-emitting elements configured to emit light;
an arrangement member including an arrangement surface on which the plurality of light-emitting elements are arranged; and
a substantially cylindrical lamp body including a light transmissive section at least in a part thereof, including the arrangement member disposed on an inside, and including a projecting body projecting from an inner wall opposed to the arrangement member and extending toward the arrangement surface.

2. The circuit according to claim 1, wherein the lamp body is divided into two along a longitudinal direction and the projecting body is provided in one of divided members.

3. The circuit according to claim 1, wherein the projecting body is a supporting plate set in contact with a surface on a rear side of an arrangement surface in the arrangement member.

4. The circuit according to claim 1, wherein the plurality of light-emitting elements are disposed along a longitudinal direction of the lamp body, and the projecting body is provided along the longitudinal direction of the lamp body and is arranged on a side of the plurality of light-emitting elements.

5. The circuit according to claim 1, wherein
the projecting body includes an end face opposed to the arrangement surface of the arrangement member, and
light emitted from the light-emitting element is made incident on insides of the projecting body and the lamp body from the end face, whereby the lamp body functions as a light guide path.

6. A luminaire comprising:
a light-emitting circuit including a plurality of light-emitting elements configured to emit light, an arrangement member including an arrangement surface on which the plurality of light-emitting elements are arranged, and a substantially cylindrical lamp body including a translucent section at least in a part thereof, including the arrangement member disposed on an inside, and including a projecting body projecting from an inner wall opposed to the arrangement member and extending toward the arrangement surface; and
a luminaire main body in which the light-emitting circuit is disposed.
